(19) United States
(12) Patent Application Publication
(10) Pub. No.: US 2006/0064533 A1
(43) Pub. Date: Mar. 23, 2006

(54) Configurable network of personal environment electronic equipment

(76) Inventors: Jacob J. Rael, Lake Forest, CA (US); Henry Rael, Albuquerque, NM (US)

Correspondence Address: GARLICK HARRISON & MARKISON LLP, P.O. BOX 160727, AUSTIN, TX, 78716-0727, US

(21) Appl. No.: 11/048,349

(22) Filed: Feb. 1, 2005

Related U.S. Application Data
(63) Continuation-in-part of application No. 10/944,508, filed on Sep. 17, 2004.

(51) Int. Cl. G06F 13/36

(52) U.S. Cl. 710/310

(57) ABSTRACT

A method for configuring a network of personal environment electronic equipment begins by receiving, by a master component of the network of personal environment electronic equipment, a user input identifying one of a plurality of slave components of the network of personal environment electronic equipment to produce identified slave component. The method continues by retrieving, by the master component, an application relating to operation of the identified slave component based on the user input. The method continues by establishing, by the master component, a connection via a communication channel with the identified slave component. The method continues by receiving, by the master component, an instructions regarding operation of the identified slave component. The method continues, when the connection with the identified slave component is established, by providing, by the master component, at least a representation of the instruction to the identified slave component via the communication channel.

This patent application is claiming priority under 35 USC § 120 as a continuation in part patent application to co-pending patent application entitled CONFIGURABLE ENTERTAINMENT NETWORK, having a Ser. No. of 10/944,508, and a filing date of Sep. 17, 2004.

### BACKGROUND OF THE INVENTION

1. Technical Field of the Invention

This invention relates generally to networking and more particularly to configuring a network of personal environment electronic equipment.

2. Description of Related Art

As is known, a home and/or office includes a plurality of electronic devices that add to a person's comfort level, increases access to information, and provides entertainment. Such electronic devices include air conditioners, heaters, coffee makers, microwave ovens, television, computers, internet access devices, personal digital assistants, DVD players, satellite receivers, cable set top boxes and so on. Each of these electronic devices includes its own control panel for controlling operation of the device. For example, a thermostat controls the operation of an air conditioning unit and/or a heater.

In most homes and offices, such varied electronic equipment is not networked together for control from a single point. If networking is used, the network couples like components together. For example, computers and associated computer equipment (e.g., printers, fax machines, and servers) are networked together. In home networking exists in a similar fashion. As such, multiple networks may exist in a home and/or office, with many electronic devices being stand-alone devices (i.e., not coupled into any of the networks).

Coupling components of a network together is typically done through direct connect wiring. For example, a remote control panel is direct wire coupled to a security system; a thermostat is direct wire coupled to an air conditioning unit and/or heater; components of an entertainment system are direct wire coupled. Such direct wire coupling includes a significant number of wires that most users desire to hide in a wall; making access to such wires difficult.

Typically, once a network is set-up via direct wire coupling, adding or removing components from the system is a rather involved task. For instance, assume that the user desires to add a satellite receiver to an entertainment system. In this instance, the user would direct wire couple the satellite receiver to a system receiver, which may or may not have inputs to accommodate the satellite receiver and will require a physical manipulation of the existing direct wire coupling. Once the satellite receiver is wired in, an even larger number of wires would again need to be hidden in the wall. Similar issues arise when a component is removed from the system.

Therefore, a need exists for a user-friendly method and apparatus of configuring and/or reconfiguring a network of personal environment electronic equipment.

### BRIEF SUMMARY OF THE INVENTION

The configurable network of personal environment electronic equipment of the present invention substantially meets these needs and others. In one embodiment, a method for configuring a network of personal environment electronic equipment begins by receiving, by a master component of the network of personal environment electronic equipment, a user input identifying one of a plurality of slave components of the network of personal environment electronic equipment to produce identified slave component. The method continues by retrieving, by the master component, an application relating to operation of the identified slave component based on the user input. The method continues by establishing, by the master component, a connection via a communication channel with the identified slave component. The method continues by receiving, by the master component, an instructions regarding operation of the identified slave component. The method continues, when the connection with the identified slave component is established, by providing, by the master component, at least a representation of the instruction to the identified slave component via the communication channel.

### BRIEF DESCRIPTION OF THE SEVERAL VIEWS OF THE DRAWINGS

FIG. 1 is a schematic block diagram of a wireless network of personal environment electronic equipment in accordance with the present invention;

FIG. 2 is a schematic block diagram of a wired network of personal environment electronic equipment in accordance with the present invention;

FIG. 3 is a schematic block diagram of a wired and wireless network of personal environment electronic equipment in accordance with the present invention;

FIGS. 4A-4C are an example of operation of a network of person environment electronic equipment in accordance with the present invention;

FIG. 5 is a schematic block diagram of virtual connection within a network of personal environment electronic equipment in accordance with the present invention; and

FIG. 6 is a logic diagram of a method for configuring a network of personal environment electronic equipment in accordance with the present invention.

### DETAILED DESCRIPTION OF THE INVENTION

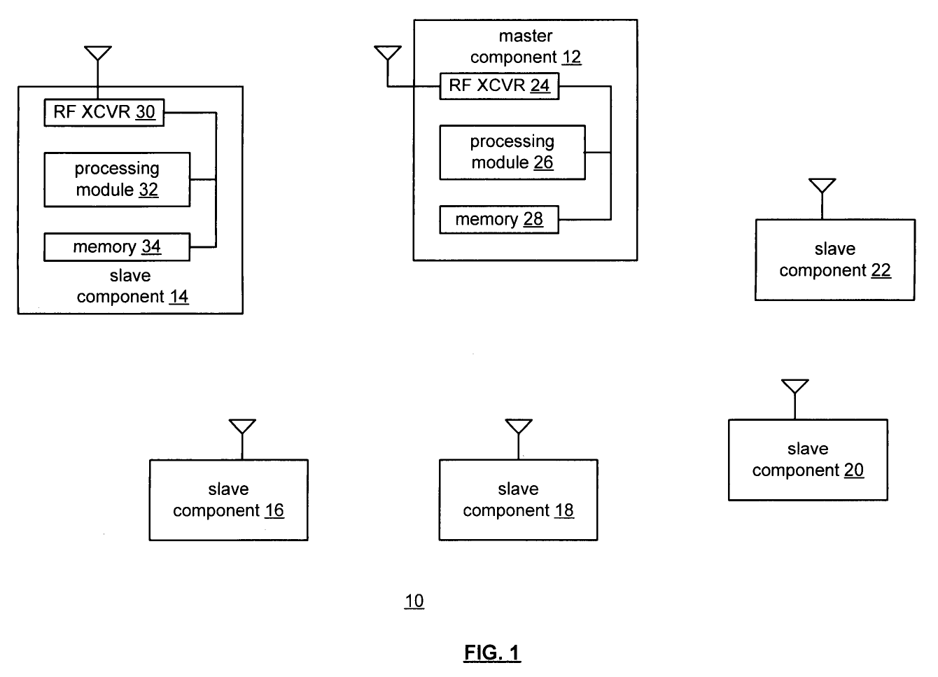

FIG. 1 is a schematic block diagram of a wireless network 10 of personal environment electronic equipment. The network 10 includes a master component 12 and a plurality of slave components 14-22. The master component 12 includes a radio frequency (RF) transceiver (XCVR) 24, a processing module 26, and memory 28. Slave component 14, which is representative of the other slave components 16-22, includes a radio frequency transceiver 30, processing module 32, and memory 34. The RF transceivers 24 and 30 may be in accordance with one or more wireless communication standards. For example, the RF transceivers 24 and 30 may be constructed in accordance with one or more versions of the Bluetooth standard, one or more versions of IEEE 802.11, et cetera.

The processing modules 26 and 32 may each be individual processing devices and/or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 28 and 34 may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing module 26 or 32 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. The memory 28 and/or 34 stores, and the processing module 26 and/or 32 executes, operational instructions corresponding to at least some of the functions illustrated in FIGS. 1-6.

To setup the wireless network 10 one or more of the components is designated as a master component. In this example, component 12 is designated as the master. Such components may include electronic equipment that controls the climate of a personal environment (e.g., a home, a room, and/or an office), provides entertainment, provides means for communication, provides means for preparing food and/or beverages, provides security, provides health care assistance, provides maintenance, etc. As a more particular example, the electronic components may include, but is not limited to, a system receiver, a subscription receiver (e.g., cable set-top box, satellite receiver, broadcast receiver, playback and/or recorder device), CD player, DVD player, VCR, video disk, computing device (e.g., personal computer, laptop, personal digital assistant (PDA)), video display device (e.g., Cathode ray tube (CRT), LCD monitor, TV monitor, video projector), and audio display device (e.g., speakers, headphones), security camera, security system, kitchen appliance (e.g., microwave oven, coffee maker, stove, refrigerator), air conditioning unit, dehumidifier, humidifier, heating system, thermostat, baby monitor, fire sensor, water sensor, sprinkler system, robotic lawn mover, robotic vacuum cleaner, interior lighting, and exterior lighting. Note that, if more than one component is selected as the master component, the master components would distribute the master functionality.

The setup of a wireless network 10 begins when the master component 12 polls the slave components via a wireless channel to identify the active slave components within the network. For instance, slave component 14 may be off such that it is not actively within the network. Note that the polling may be done in accordance with a wireless communication standard, e.g., one or more versions of Bluetooth, IEEE 802.11. Further, the polling may be done by obtaining a system identification code for each of the slave components and addressing the slave components by the system identification code. The user of the system may assign the system identification codes via a user input of the entertainment network or the components may establish individual system identification codes via an auto-negotiation.

Upon receiving the poll request, each of the active slave components provides a profile response to the master component via the wireless communication channel. In general, the profile includes the device type, operations, control panel input/output configuration, per-operation capabilities, and/or any other information relating to the type of device, its operation, and control thereof.

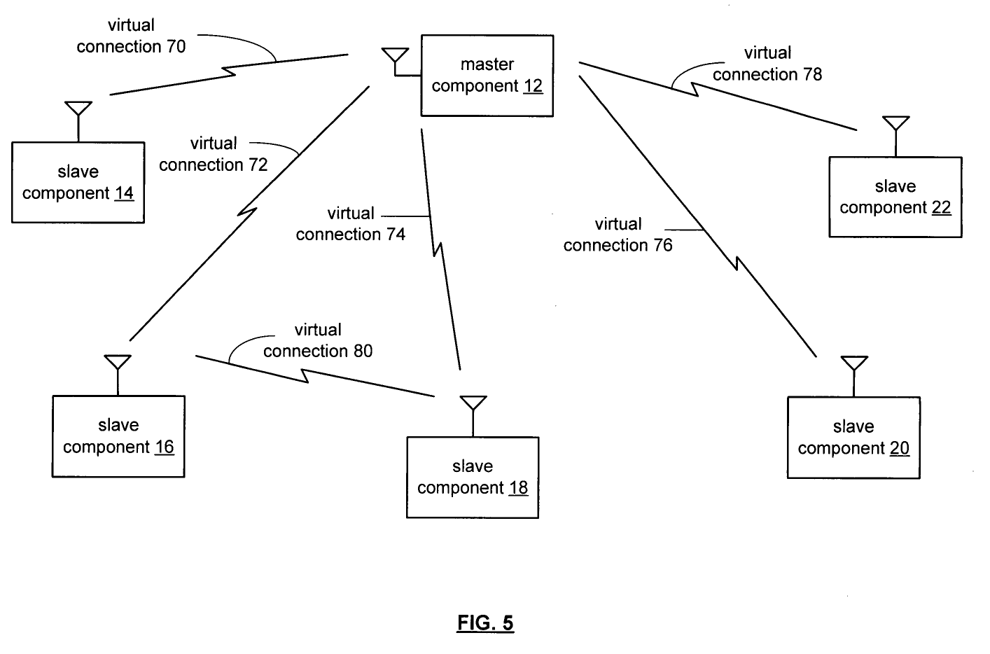

Upon receiving the profile responses from the active slaves, the master component 12 establishes virtual connections with the slave components and/or between the slave components. The virtual connections are based on possible desired communications at the appropriate bandwidths from one component to another within network 10. As such, the virtual connections may be between the slave components, from a slave component to a master component and/or from a single component to multiple components. The virtual connections will be described in greater detail with the examples of FIG. 5. As one of ordinary skill in the art will appreciate, the setup of the network 10 includes establishing a virtual connection map that indicates possible wireless connections between the components 12-22 of the network. The particular connections made will depend on user inputs as to how the network 10 will be utilized. As one of ordinary skill in the art will further appreciate, the wireless network 10 may use one or more wireless communication channels of one or more wireless standards. For example, one or more channels of the Bluetooth standard may be utilized, or versions thereof, and/or one or more channels of the IEEE 802.11 standards, or versions thereof, may be used.

Once the network 10 is set up, the master component 12 may receive a user input regarding the operation of one or more of the components of the network 10. The user input may be directly received by the master component 12 via an input mechanism (e.g., keyboard, keypad, touch screen, voice recognition, remote control etc.) of the master component 12 or via a slave component. For example, if the master component 12 is a computer, it may receive the input directly via computer inputting means or, if a slave component is a PDA, the PDA may receive the input and forward it to the master component. With respect to the later, a user may be anywhere in the vicinity of the personal environment (e.g., home, office, room, etc.) and control a component of the network 10. As an alternative to the slave component (e.g., PDA) forwarding the user input to the master component (e.g., computer), the master component may transfer master control to the slave component for this particular user input or in general. Transfer of master control may be done in accordance with the applicable wireless communication standard being utilized by the network 10.

Upon receiving the user input, the master component 12 determines which slave component or components is identified within the user input. Upon identifying the slave component, the master component 12 retrieves an application related to operation of the identified slave component. Such an application may be to extend the control panel of the identified slave component to a display of the master component 12 such that the display of the master component, with respect to the user, is the control panel of the slave component. For example, if the identified slave component is an air conditioning unit, the application would function to provide the control panel of the appropriate thermostat on the display of the master. In this instance, the display of the master component 12 would present the user with control options presented on the thermostat (e.g., setting cooling program, turn on/off, adjust temperature, etc.). Upon detection a user instruction, the master component provides the instruction to the identified slave component for execution by the identified slave component. Accordingly, for any component in the network, the master component may function as a remote control panel of the identified slave device and pass the corresponding user commands to the identified slave component for execution. As one of ordinary skill in the art will appreciate, the identified slave component may provide a response back to the master component to indicate that the instruction has been properly executed or otherwise.

As an alternative, the application may be a custom application for controlling the identified slave component, where the application is stored on the network and is accessible by the master component (e.g., stored by the master component, stored by a server, etc.). In this instance, the master component 12 provides the user with a menu of functions relating to the custom operations for controlling the identified slave component.

For example, the identified slave component may be a sprinkler system. The custom application may provide operational options that establish the watering cycle of each zone of the sprinkling system and monitoring of local weather conditions to automatically adjust the sprinkler settings based on recent, current, and/or up-coming weather. For instance, if a lawn has received five inches of rain over the past week, the sprinkler system can be shut off for a number of days, where the number of days may be dependent on the up-coming forecast (e.g., few days if the forecast is for hot and dry, more days if the forecast is cloudy and cool). In one embodiment, the present type of application replaces the programming provided by the identified slave component. In another embodiment, the present type of application works with the programming of the identified slave component to achieve the desired results.

As another alternative application, the master component may simply forward the user input to the identified slave component without processing or functioning as the control panel of the identified slave component. As one of ordinary skill in the art will appreciate, there is a variety of ways to forward user inputs to the slave component for execution.

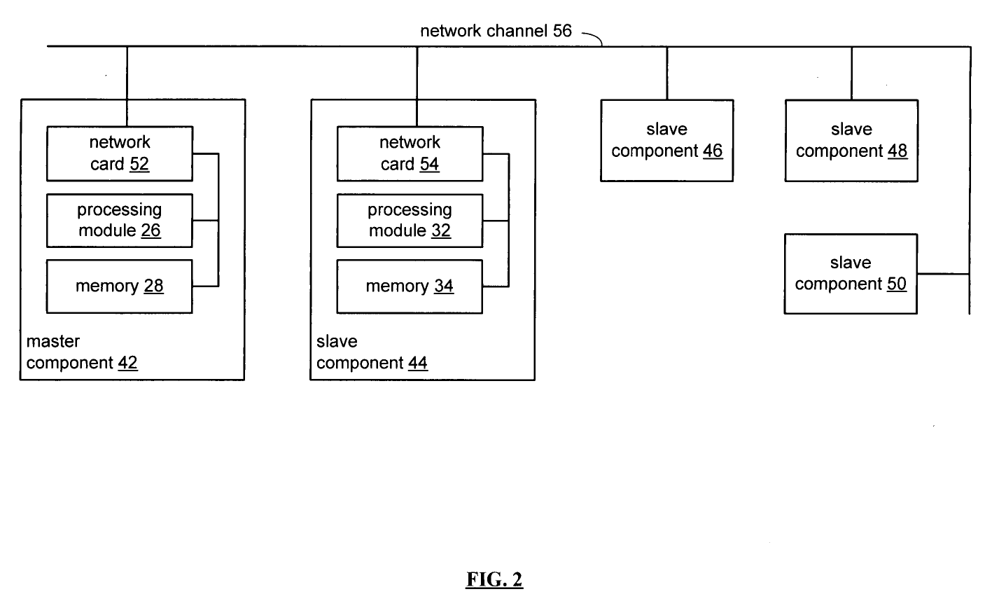

FIG. 2 is a schematic block diagram of a wired network 40 that includes a master component 42 and slave components 44-50. The master component 42 includes a network card 52, processing module 26 and memory 28. The slave component 44, which is representative of the other slave components 46-50, includes a network card 54, processing module 32 and memory 34. The components 42-50 may include electronic equipment that controls the climate of a personal environment (e.g., a home, a room, and/or an office), provides entertainment, provides means for communication, provides means for preparing food and/or beverages, provides security, provides health care assistance, provides maintenance, etc. As a more particular example, the electronic components may include, but is not limited to, a system receiver, a subscription receiver (e.g., cable set-top box, satellite receiver, broadcast receiver, playback and/or recorder device), CD player, DVD player, VCR, video disk, computing device (e.g., personal computer, laptop, personal digital assistant (PDA)), video display device (e.g., Cathode ray tube (CRT), LCD monitor, TV monitor, video projector), and audio display device (e.g., speakers, headphones), security camera, security system, kitchen appliance (e.g., microwave oven, coffee maker, stove, refrigerator), air conditioning unit, dehumidifier, humidifier, heating system, thermostat, baby monitor, fire sensor, water sensor, sprinkler system, robotic lawn mover, robotic vacuum cleaner, interior lighting, and exterior lighting. Note that, if more than one component is selected as the master component, the master components would distribute the master functionality.

The network cards 52 and 54 provide the components 42-50 with connectivity to a network channel 56. The network channel 56 may be an Ethernet connection, fire wire connection, and/or a standardized wire network protocol channel. The network cards 52 and 54 will function in accordance with the particular wired standard supported by the network channel 56.

The master component 42 establishes virtual connections between itself and the slave components 44-50 and interoperation therebetween is as previously described with reference to FIG. 1. In this embodiment, the communication path is via the network channel 56 as opposed to a wireless communication channel of FIG. 1.

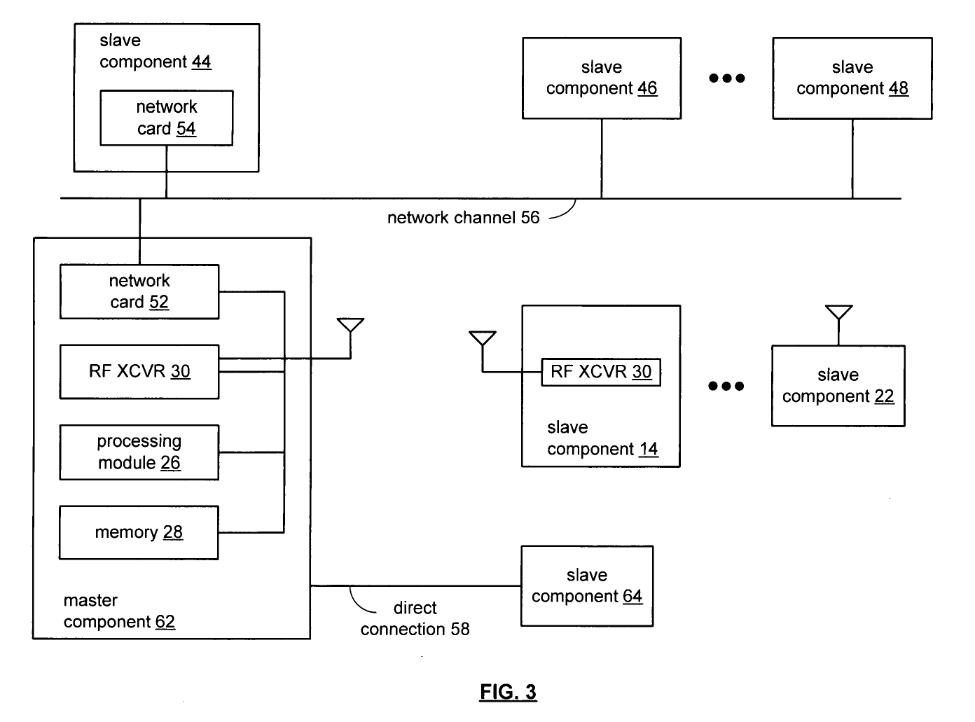

FIG. 3 is a schematic block diagram of a wired and wireless network 60. In this embodiment, the network 60 includes master component 62, wired slave components 44-48, wireless slave components 14-22 and a direct connect slave component 64. The master component 62 includes the network card 52, the RF transmitter 30, the processing module 26, and the memory 28. The wired slave components 44-48 each include a network card 54 and are coupled to a network channel 56. Each of the wireless slave components 14-22 includes a radio frequency transceiver 30.

The setup of this network entertainment 60 includes a direct connection 58 between slave component 64 and master component 62. Virtual connections via the wired communication channel 56 may be established as previously described with reference to FIGS. 1 and 2. The virtual connections via the wireless communication channel, or channels, may be established as previously described with reference to FIG. 1.

As one of ordinary skill in the art will appreciate, by providing wired and/or wireless network connectivity between the components of a network of personal environment electronic equipment, the network may be readily configured and re-configured without the hassles of rewiring direct connections.

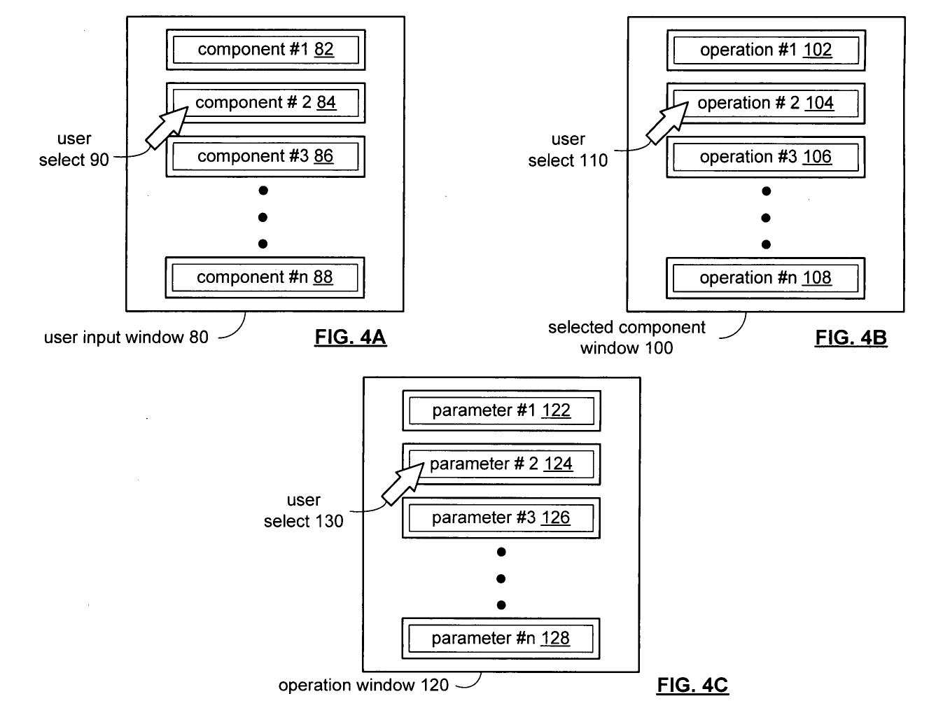

FIGS. 4A-4C are an example of operation of a network of person environment electronic equipment. In FIG. 4A, the display of the master component, or a slave component, provides a user input window 80 that lists all of the active slave components 82-88 of the network upon an initiation by the user. The user selects 90 one of the components to be controlled.

FIG. 4B illustrates a selected component window 100 that is provided on the display of the master component, or slave component, in response to the user select 90. In this window 100, the user is presented with one or more operational options 102-108. From this window 100, the user selects 110 a particular operation 104. For example, the identified component 84 may be a sprinkler system and the selected operation may be water timing.

FIG. 4C illustrates an operation window 120 that is provided on the display of the master component, or the slave component, in response to the user select 110. As shown, this window 120 provides one or more parameters 122-124 of the selected operation 104 that can be adjusted. Continuing with the above example of a sprinkler system, the parameters may include zones, days on, days off, start time, duration of watering per zone, etc. As one of ordinary skill in the art will appreciate, any component connected to the network may be controlled in this manner, thus providing a user-friendly method and apparatus of configuring and/or reconfiguring a network of personal environment electronic equipment.

FIG. 5 is an example of the master component 12 establishing virtual connections 70-80 within the wireless entertainment network 10. The same concepts of establishing virtual connections are applicable to the systems of FIGS. 2 and 3. In this example, based on a profile table containing the profile of each component of the network, the master component 12 establishes various virtual connections 70-80 between the slave components and itself and between the slave components.

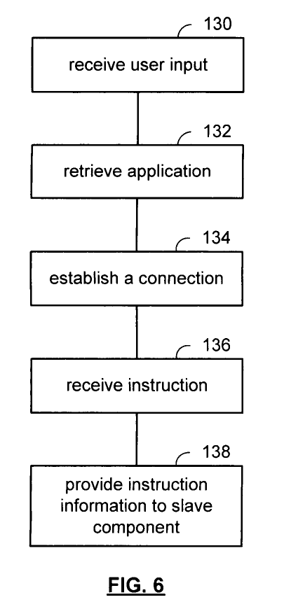

FIG. 6 is a logic diagram of a method for configuring a network of personal environment electronic equipment that begins at step 130 where the master component receives a user input identifying one of a plurality of slave components of the network of personal environment electronic equipment to produce identified slave component. In one embodiment, the user input is received in accordance with activation of an input of the master component (e.g., use of a key pad to enter the user input). In another embodiment, the master component receives the user input repeatedly in accordance with a periodic sequence of a retrieved application to automatically control the identified slave component. In yet another embodiment, a slave component of the network of personal environment electronic equipment receives the user input and forwards it to the master component. In this instance, the master component maintains master control and the slave component functions as the user input device. In a further embodiment, a slave component receives the user input and requests master control from the master component. If the slave component is authorized to have master control (as may be pre-established by user, or upon some other verification process), the master component transfers master control to the slave component, who, at least for this communication, becomes the master component.

The process then proceeds to step 132 where the master component retrieves an application relating to operation of the identified slave component based on the user input. In one embodiment, the application is the graphical user interface extension program that provides a graphical control panel corresponding to a control panel of the identified slave component; detects the instruction via the graphical control panel; equates the instruction to a command of the control panel of the identified slave; and provides the command to the identified slave component. In another embodiment, the application is the device control application that provides a graphical control panel representing adjustable operational parameters of the identified slave component; detects the instruction via the graphical control panel; processes the instruction to determine an adjustment of an operational parameter of the identified slave component to produce an adjustment command; and provides the adjustment command to the identified slave component. In yet another embodiment, the application is the forwarding application that provides a graphical control panel representing adjustable operational parameters of the identified slave component; receives the instruction via the graphical control panel; and provides the instruction to the identified slave component for processing by the slave component application.

The process then proceeds to step 134 where the master component establishes a connection via a communication channel (e.g., wired and/or wireless) with the identified slave component. In one embodiment, the communication channel is established by activating a virtual connection. A virtual connection may be established by polling, by the master component, the slave components via the communication channel to identify active slave components of the network of personal environment electronic equipment; providing, by each of the active slave components, a profile response to the master component via the communication channel in response to the polling; determining, by the master component, operational parameters of the active slave components and configuration options of the network of personal environment electronic equipment based on the profile responses of the active slave components and a profile of the master component; and based on the operational parameters and the configuration options, establishing, by the master component, a virtual connection between the master component and at least one of the active slave components, and/or a virtual connection between a first one of the active slave components and a second one of the active slave components. In yet another embodiment, the communication channel may be established by periodically establishing the connection with the identified slave component and/or by alternatingly establishing the connection with the plurality of slave components (e.g., a round robin establishment of a connection with each slave component and among the slave components).

The process then proceeds to step 136 where the master component receives an instruction regarding operation of the identified slave component. The process then proceeds to step 138 where, when the connection with the identified slave component is established, the master component provides at least a representation of the instruction to the identified slave component via the communication channel. For example, the master may provide the instruction itself, a command relating thereto, and/or a custom instruction.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The preceding discussion has presented a method and apparatus for configuring a network of personal environment electronic equipment. As one of ordinary skill in the art will appreciate, other embodiments may be derived from the teaching of the present invention without deviating from the scope of the claims.

What is claimed is:

1. A method for configuring a network of personal environment electronic equipment, the method comprises:
receiving, by a master component of the network of personal environment electronic equipment, a user input identifying one of a plurality of slave components of the network of personal environment electronic equipment to produce identified slave component;
retrieving, by the master component, an application relating to operation of the identified slave component based on the user input;
establishing, by the master component, a connection via a communication channel with the identified slave component;
receiving, by the master component, an instructions regarding operation of the identified slave component; and
when the connection with the identified slave component is established, providing, by the master component, at least a representation of the instruction to the identified slave component via the communication channel.

2. The method of claim 1, wherein the retrieving the application comprises at least one of:
retrieving a graphical user interface extension program to extend a control panel of the identified slave component to the master component;
retrieving a device control application that establishes operational parameters for the identified slave component; and retrieving a forwarding application to forward the instructions to the identified slave component such that the slave component executes the instructions via a slave component application.

3. The method of claim 2, wherein the providing the at least a representation of the instruction comprises, when the application is the graphical user interface extension program:
providing a graphical control panel corresponding to a control panel of the identified slave component;
detecting the instruction via the graphical control panel;
equating the instruction to a command of the control panel of the identified slave; and providing the command to the identified slave component.

4. The method of claim 2, wherein the providing the at least a representation of the instruction comprises, when the application is the device control application:
providing a graphical control panel representing adjustable operational parameters of the identified slave component;
detecting the instruction via the graphical control panel;
processing the instruction to determine an adjustment of an operational parameter of the identified slave component to produce an adjustment command; and
providing the adjustment command to the identified slave component.

5. The method of claim 2, wherein the providing the at least a representation of the instruction comprises, when the application is the forwarding application;
providing a graphical control panel representing adjustable operational parameters of the identified slave component;
receiving the instruction via the graphical control panel; and
providing the instruction to the identified slave component for processing by the slave component application.

6. The method of claim 1, wherein the establishing the connection comprises: activating a virtual connection.

7. The method of claim 6 comprises:
polling, by the master component, the slave components via the communication channel to identify active slave components of the network of personal environment electronic equipment;
providing, by each of the active slave components, a profile response to the master component via the communication channel in response to the polling;
determining, by the master component, operational parameters of the active slave components and configuration options of the network of personal environment electronic equipment based on the profile responses of the active slave components and a profile of the master component; and
based on the operational parameters and the configuration options, establishing, by the master component, at least one of:
a virtual connection between the master component and at least one of the active slave components; and
a virtual connection between a first one of the active slave components and a second one of the active slave components.

8. The method of claim 1, wherein the communication channel comprises at least one of:
a wireless communication channel; and
a wired communication channel.

9. The method of claim 1, wherein the network of personal environment electronic equipment comprises at least one of: a television, a security system, a security camera, a baby monitor, a fire sensor, a water sensor, a sprinkler system, a thermostat, a kitchen appliance, an interior lighting system, an exterior lighting system, an entertainment device, a personal digital assistant, and a computer.

10. The method of claim 1, wherein the receiving the user input comprises at least one of:
receiving the user input via activation of an input of the master component; and
repeatedly receiving the user input in accordance with a periodic inputting sequence.

11. The method of claim 1, wherein the establishing the connection comprises at least one of:
periodically establishing the connection with the identified slave component; and alternatingly establishing the connection with the plurality of slave components.

12. The method of claim 1 further comprises:
receiving, by the master component, a response from the identified slave component via the communication channel regarding the instruction.

13. The method of claim 1 further comprises:
the receiving the user input including:
receiving, by a slave component of the network of personal environment electronic equipment, the user input;
forwarding, by the slave component, the user input to the master component;
the receiving the instruction including:
receiving, by the slave component, the instruction;
forwarding, by the slave component, the user input to the master component.

14. The method of claim 1 further comprises:
receiving, by a slave component of the network of personal environment electronic equipment, the user input;
providing, by the slave component, a request to become master to the master component;
determining, by the master component, whether slave component is authorized to become the master; and
when the slave component is authorized to become the master, transferring, by the master component, master control to the slave component.

15. A master component of a network of personal environment electronic equipment, the master component comprises:
a network interface module;
a processing module operably coupled to the network interface module; and
memory operably coupled to the processing module, wherein the memory stores operational instructions that cause the processing module to:
receive a user input identifying one of a plurality of slave components of the network of personal environment electronic equipment to produce identified slave component;
retrieve an application relating to operation of the identified slave component based on the user input;
establish a connection with the identified slave component via the network interface module and a communication channel;
receive an instructions regarding operation of the identified slave component; and
when the connection with the identified slave component is established, provide at least a representation of the instruction to the identified slave component via the communication channel.

16. The master component of claim 15, wherein the memory further stores operational instructions that cause the processing module to retrieve the application by at least one of:
retrieving a graphical user interface extension program to extend a control panel of the identified slave component to the master component;
retrieving a device control application that establishes operational parameters for the identified slave component; and
retrieving a forwarding application to forward the instructions to the identified slave component such that the slave component executes the instructions via a slave component application.

17. The master component of claim 16, wherein the memory further stores operational instructions that cause the processing module to provide the at least a representation of the instruction by, when the application is the graphical user interface extension program:
providing a graphical control panel corresponding to a control panel of the identified slave component;
detecting the instruction via the graphical control panel; equating the instruction to a command of the control panel of the identified slave; and
providing the command to the identified slave component.

18. The master component of claim 16, wherein the memory further stores operational instructions that cause the processing module to provide the at least a representation of the instruction by, when the application is the device control application:
providing a graphical control panel representing adjustable operational parameters of the identified slave component;
detecting the instruction via the graphical control panel;
processing the instruction to determine an adjustment of an operational parameter of the identified slave component to produce an adjustment command; and
providing the adjustment command to the identified slave component.

19. The master component of claim 16, wherein the memory further stores operational instructions that cause the processing module to provide the at least a representation of the instruction by, when the application is the forwarding application;
providing a graphical control panel representing adjustable operational parameters of the identified slave component;
receiving the instruction via the graphical control panel; and
providing the instruction to the identified slave component for processing by the slave component application.

20. The master component of claim 15, wherein the memory further stores operational instructions that cause the processing module to establish the connection by: activating a virtual connection.

21. The master component of claim 20, wherein the memory further stores operational instructions that cause the processing module to:
poll the slave components via the communication channel to identify active slave components of the network of personal environment electronic equipment;
provide a profile response to the master component via the communication channel in response to the polling;
determine operational parameters of the active slave components and configuration options of the network of personal environment electronic equipment based on the profile responses of the active slave components and a profile of the master component; and
based on the operational parameters and the configuration options, establish at least one of:
a virtual connection between the master component and at least one of the active slave components; and
a virtual connection between a first one of the active slave components and a second one of the active slave components.

22. The master component of claim 15, wherein the communication channel comprises at least one of:
a wireless communication channel; and
a wired communication channel.

23. The master component of claim 15 comprises, within the network of personal environment electronic equipment, at least one of: a television, a security system, a security camera, a baby monitor, a fire sensor, a water sensor, a sprinkler system, a thermostat, a kitchen appliance, an interior lighting system, an exterior lighting system, an entertainment device, a personal digital assistant, and a computer.

24. The master component of claim 15, wherein the memory further stores operational instructions that cause the processing module to receive the user input by at least one of:
receiving the user input via activation of an input of the master component; and
repeatedly receiving the user input in accordance with a periodic inputting sequence.

25. The master component of claim 15, wherein the memory further stores operational instructions that cause the processing module to establish the connection by at least one of:
periodically establishing the connection with the identified slave component; and
alternatingly establishing the connection with the plurality of slave components.

26. The master component of claim 15, wherein the memory further stores operational instructions that cause the processing module to:
receive a response from the identified slave component via the communication channel regarding the instruction.

27. The master component of claim 15, wherein the memory further stores operational instructions that cause the processing module to:
receive the user input by:
receiving, by a slave component of the network of personal environment electronic equipment, the user input;
forwarding, by the slave component, the user input to the master component;
receive the instruction by:
receiving, by the slave component, the instruction;
forwarding, by the slave component, the user input to the master component.

28. The master component of claim 15, wherein the memory further stores operational instructions that cause the processing module to:
receive a request to become master from a slave component of the network of personal environment electronic equipment that received the user input;
determine whether slave component is authorized to become the master; and
when the slave component is authorized to become the master, transfer master control to the slave component.
